(19) United States
(12) Patent Application Publication
(10) Pub. No.: US 2022/0206742 A1
(43) Pub. Date: Jun. 30, 2022

(54) AGENT DISPLAY METHOD, NON-TRANSITORY COMPUTER READABLE MEDIUM, AND AGENT DISPLAY SYSTEM

(71) Applicant: TOYOTA JIDOSHA KABUSHIKI KAISHA, Toyota-shi Aichi-ken (JP)

(72) Inventors: Ryosuke Nakanishi, Nisshin-shi Aichi-ken (JP); Hikaru Sugata, Miyoshi-shi Aichi-ken (JP)

(21) Appl. No.: 17/556,275

(22) Filed: Dec. 20, 2021

(30) Foreign Application Priority Data
Dec. 25, 2020 (JP) 2020-216963

(51) Int. Cl. G06F 3/16; G06F 16/33; G06F 16/332

(52) U.S. Cl. CPC G06F 3/167; G06F 16/3329; G06F 16/3344

(57) ABSTRACT

The present disclosure provides an agent display method and the like that reduces the trouble of a user confirming an answer (or answers) while increasing the possibility of presenting an answer (or answers) of high value to the user without omission. An agent display method for simultaneously displaying a plurality of agents each configured to respond to a speech text of a user, the agent display method including: an answer selection step of selecting the answer text of each of the plurality of agents to the speech text of the user; and an agent display step of displaying a screen including the plurality of agents, in which the agent display step includes displaying the agent that the user should check first among the plurality of agents in a more emphasized form than those of the agents other than the agent that the user should check first.

### CROSS REFERENCE TO RELATED APPLICATIONS

This application is based upon and claims the benefit of priority from Japanese patent application No. 2020-216963, filed on Dec. 25, 2020, the disclosure of which is incorporated herein in its entirety by reference.

### BACKGROUND

The present disclosure relates to an agent display method, a non-transitory computer readable medium, and an agent display system, and, in particular, to an agent display method, a non-transitory computer readable medium, and an agent display system that reduces the trouble of a user confirming an answer (or answers) while increasing the possibility of presenting an answer (or answers) of high value to the user without omission.

A Frequently Asked Questions (FAQ) chat bot system has been introduced for the purpose of improving the efficiency of responses to inquiries. A chatbot (hereinafter referred to as an agent) is a system that retrieves an answer to a user's question from a database (DB) of an FAQ using certain logic and displays the retrieved answer.

For example, Japanese Unexamined Patent Application Publication No. 2020-34626 discloses an agent management method for displaying, as an agent responding to a user speech text (utterance sentence), an agent (an agent including a user assumed text having a degree of similarity of a predetermined threshold or higher and the highest threshold) that satisfies a predetermined condition among a plurality of agents.

### SUMMARY

In the agent management method disclosed in Japanese Unexamined Patent Application Publication No. 2020-34626, it is possible to check an answer of the agent that responds to the user speech text. However, there is a problem that a user does not have an opportunity to check an answer (e.g., an answer that is more valuable to the user than the answer of the agent that responds to the user speech text) other than the answer of the agent that responds to the user speech text.

In order to address this problem, it is conceivable to simultaneously display a plurality of agents (including the respective answers thereof). However, in this case, there is a problem that a user needs to check a plurality of answers each time.

The present disclosure has been made in order to solve such a problem, and provides an agent display method, a non-transitory computer readable medium, and an agent display system that reduces the trouble of a user confirming an answer (or answers) while increasing the possibility of presenting an answer (or answers) of high value to the user without omission.

A first exemplary aspect is an agent display method for simultaneously displaying a plurality of agents each configured to respond to a speech text of a user, the agent display method including: a speech text acquisition step of acquiring the speech text of the user; an answer selection step of selecting, from a database of each of the agents storing a question text and an answer text corresponding to the question text, the answer text of each of the plurality of agents to the speech text of the user; and an agent display step of displaying a screen including the plurality of agents, in which the agent display step includes displaying the agent that the user should check first among the plurality of agents in a more emphasized form than those of the agents other than the agent that the user should check first.

By this configuration, it is possible to reduce the trouble of a user confirming an answer (or answers) while increasing the possibility of presenting an answer (or answers) of high value to the user without omission.

The reason why it is possible to increase the possibility of presenting all answers valuable to a user is that the answer texts of the plurality of respective agents are displayed. The reason why it is possible to help to prevent a user from being subject to the inconvenience of having to check answers is that the agent that the user should check first is displayed in a more emphasized form than those of the other agents.

Note that the screen may include an agent image symbolizing the agent that the user should check first and agent images symbolizing the other agents, and the agent image symbolizing the agent that the user should check first may be displayed in a size larger than those of the agent images symbolizing the other agents.

Further, the screen may include a first display area and a second display area, the first display area may be larger than the second display area, the agent that the user should check first may be displayed in the first display area, and the other agents may be displayed in the second display area.

Further, the screen may include the answer text of the agent that the user should check first and the answer texts of the other agents, and the answer text of the agent that the user should check first may be displayed in a size larger than those of the answer texts of the other agents.

Further, the agent that the user should check first may be displayed in density higher than those of the other agents.

Further, the other agent may be displayed so that the other agents surround the agent that the user should check first.

Further, the screen may further include an additional display that is additionally displayed near the agent that the user should check first.

Further, the agent that the user should check first may be displayed so that it blinks.

Further, the agent that the user should check first may be displayed as a moving image, and the other agents may be displayed as still images.

Further, the screen may further include displays showing organizations to which the plurality of respective agents belong.

Further, the answer selection step may include selecting the answer texts of the plurality of respective agents to the speech text of the user from the database based on a degree of similarity between the speech text of the user and the question text stored in the database.

Further, the answer selection step may include selecting the answer texts of the plurality of respective agents to the speech text of the user from the database based on the degree of similarity between the speech text of the user and the question text stored in the database and a feature of the agent.

Further, the answer text of the agent that the user should check first may be the answer text corresponding to the question text among the answer texts of the plurality of respective agents selected in the answer selection step, the question text having a highest degree of similarity to the answer text.

Further, the answer text of each of the plurality of agents to the speech text of the user may be an overview of the answer text.

Further, the agent display method may further include: a selection receiving step of receiving the selection performed by the user with regard to the agents; and a step of displaying a detail of the answer text of the agent selected by the user from among the agents.

Another exemplary aspect is a non-transitory computer readable medium storing a program for causing an information processing apparatus including at least one processor to execute: speech text acquisition processing of acquiring a speech text of a user; answer selection processing of selecting, from a database of each of a plurality of agents storing a question text and an answer text corresponding to the question text, the answer text of each of the plurality of agents to the speech text of the user; and agent display processing of displaying a screen including the plurality of agents, in which the agent display processing includes displaying the agent that the user should check first among the plurality of agents in a more emphasized form than those of the agents other than the agent that the user should check first.

Another exemplary aspect is an agent display system configured to simultaneously display a plurality of agents each configured to respond to a speech text of a user, the agent display system including: a speech text acquisition unit configured to acquire the speech text of the user; an answer selection unit configured to select, from a database of each of the agents storing a question text and an answer text corresponding to the question text, the answer text of each of the plurality of agents to the speech text of the user; and an agent display unit configured to display a screen including the plurality of agents, in which the agent display unit displays the agent that the user should check first among the plurality of agents in a more emphasized form than those of the agents other than the agent that the user should check first.

By the above configuration, it is possible to reduce the trouble of a user confirming an answer (or answers) while increasing the possibility of presenting an answer (or answers) of high value to the user without omission.

The reason why it is possible to increase the possibility of presenting all answers valuable to a user is that the answer texts of the plurality of respective agents are displayed. The reason why it is possible to help to prevent a user from being subject to the inconvenience of having to check answers is that the agent that the user should check first is displayed in a more emphasized form than those of the other agents.

According to the present disclosure, it is possible to provide an agent display method, a non-transitory computer readable medium, and an agent display system that reduces the trouble of a user confirming an answer (or answers) while increasing the possibility of presenting an answer (or answers) of high value to the user without omission.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic configuration diagram of an agent display system 1;

FIG. 2 shows an example of information (agent information) about each of a plurality of agents stored in an agent information storage unit 11b;

FIG. 3 is a sequence diagram of an operation example of the agent display system 1;

FIG. 4 is a sequence diagram of an operation example of the agent display system 1;

FIG. 5 is a flowchart of an operation example (a user speech analysis) of a user speech analysis unit 12b;

FIG. 6 shows an example of a screen displayed on a display unit 26;

FIG. 7 shows a modified example 1 of a screen displayed on the display unit 26;

FIG. 8 shows a modified example 2 of a screen displayed on the display unit 26; and

FIG. 9 shows a modified example 4 of a screen displayed on the display unit 26.

### DESCRIPTION OF EMBODIMENTS

An agent display system 1 according to an embodiment of the present disclosure will be described hereinafter with reference to the accompanying drawings. The same components are denoted by the same reference signs throughout the drawings, and redundant descriptions will be omitted.

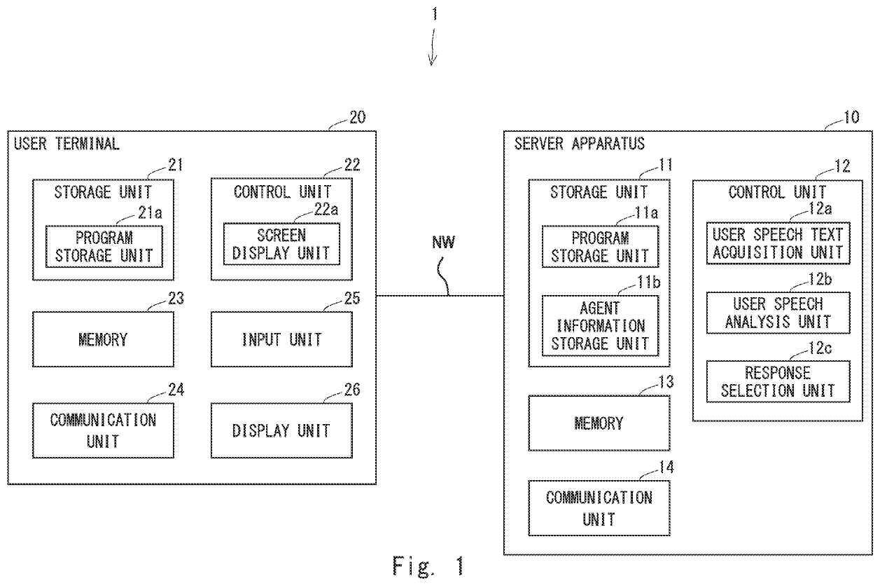

FIG. 1 is a schematic configuration diagram of the agent display system 1.

First, an outline of the agent display system 1 will be described.

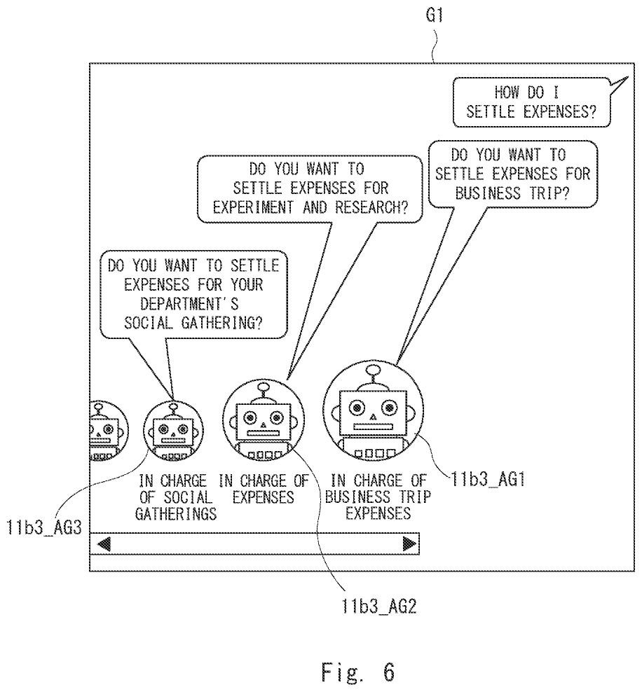

The agent display system 1 is a system that simultaneously displays a plurality of agents responding to a speech text (utterance sentence) of a user. In the agent display system 1, a screen (see, for example, a screen G1 shown in FIG. 6) including an agent image symbolizing each of the plurality of agents, an answer (e.g., an overview) of each of the plurality of agents to the speech text of the user, and the like is displayed. At this time, the agent that the user should check first (to be preferentially checked by the user) among the plurality of agents is displayed in a more emphasized form than those of the agents other than the agent that the user should check first. For example, the agent that the user should check first is displayed in a size larger than those of the other agents (e.g., agent images 11b3_AG2 and 11b3_AG3), like that of an agent (e.g., an agent image 11b3_AG1) shown in FIG. 6. When one of the plurality of agents (the agent images) is selected by the user (e.g., the user hovers the mouse over it), the answer (e.g., the detail) of the selected agent is displayed.

Next, the agent display system 1 will be described in detail.

As shown in FIG. 1, the agent display system 1 includes a server apparatus 10 and a user terminal 20. The server apparatus 10 and the user terminal 20 are connected to each other via a network NW (e.g., the Internet), and can communicate with each other via the network NW.

### <Configuration Example of the Server Apparatus 10>

First, a configuration example of the server apparatus 10 will be described.

The server apparatus 10 is, for example, an information processing apparatus such as a personal computer. The server apparatus may be a physical server or a virtual server on the network NW. The server apparatus 10 includes a storage unit 11, a control unit 12, a memory 13, and a communication unit 14.

The storage unit 11 is, for example, a nonvolatile storage unit such as a hard disk device or a Read Only Memory (ROM). The storage unit 11 includes a program storage unit 11a and an agent information storage unit 11b.

The program storage unit 11a stores programs to be executed by the control unit 12 (a processor).

The agent information storage unit 11b stores information (agent information) about each of a plurality of agents.

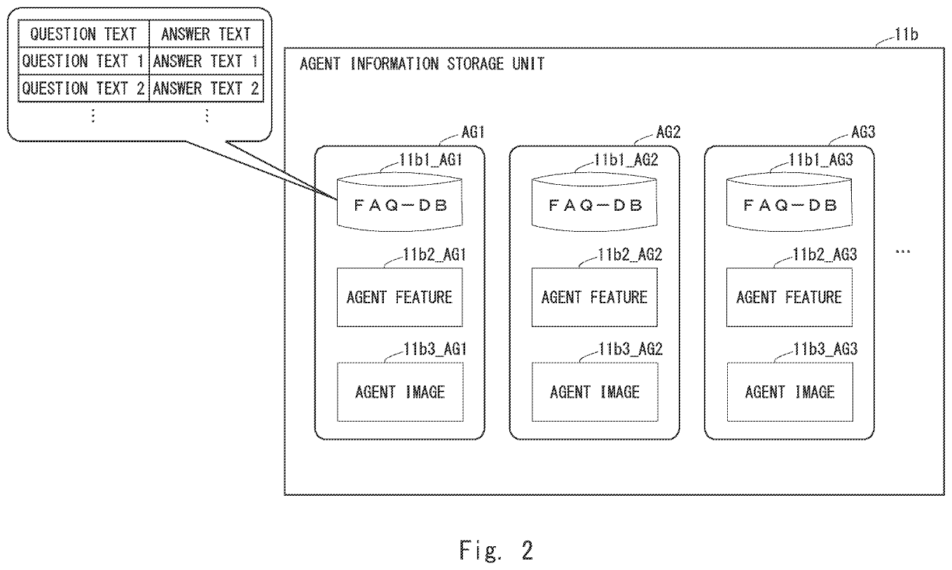

FIG. 2 shows an example of the information (the agent information) about each of the plurality of agents stored in the agent information storage unit 11b. In FIG. 2, information (agent information) about three respective agents AG1 to AG3 is shown.

As shown in FIG. 2, the agent information about the agent AG1 includes an FAQ-DB 11b1_AG1, an agent feature 11b2_AG1, and the agent image 11b3_AG1. The agent information about the agents AG2 and AG3 includes FAQ-DBs, agent features, and agent images similar to those included in the information about the agent AG1. Note that the agent features 11b2_AG1 to 11b2_AG3 may be omitted. In the following description, when the FAQ-DBs 11b1_AG1 to 11b1_AG3 are not particularly distinguished from each other, the FAQ-DBs 11b1_AG1 to 11b1_AG3 will be respectively referred to as the FAQ-DB 11b1. Further, when the agent features 11b2_AG1 to 11b2_AG3 are not particularly distinguished from each other, the agent features 11b2_AG1 to 11b2_AG3 will be respectively referred to as the agent feature 11b2. Further, when the agent images 11b3_AG1 to 11b3_AG3 are not particularly distinguished from each other, the agent images 11b3_AG1 to 11b3_AG3 will be respectively referred to as the agent image 11b3.

The FAQ-DB 11b1 stores “question texts” and “answer texts” as items. Note that although not shown in the figure, the FAQ-DB 11b1 may store “overviews” as an item in addition to the “question texts” and the “answer texts”.

For example, question texts (e.g., text data) and text vectors thereof are stored in the “question texts”. Answer texts (e.g., text data) corresponding to the “question texts” are stored in the “answer texts”. Overviews (summaries) of the “answer texts” are stored in the “overviews”. The “overviews” may be created manually (by a person) in advance or generated dynamically by a machine. When a machine dynamically generates the “overviews”, for example, it may generate, by using a machine learning method such as seq2seq DNN, the “overviews” each time using the “question texts” stored in the FAQ-DB 11b1 as inputs.

The agent feature 11b2 is, for example, a feature word representing a feature of the agent. The feature of the agent may be defined manually in advance, or may be created mechanically from the FAQ-DB 11b1 (the answer texts stored in the “answer texts”) by using a method such as Term Frequency-Inverse Document Frequency (tf-idf).

The control unit 12 includes the processor (not shown). The processor is, for example, a Central Processing Unit (CPU). The control unit 12 may include one or a plurality of processors. The processor executes a program loaded from the storage unit 11 (the program storage unit 11a) into the memory 13 (e.g., Random Access Memory (RAM)), thereby functioning as a user speech text acquisition unit 12a, a user speech analysis unit 12b, and a response selection unit 12c. Some or all of these may be implemented by hardware.

The user speech text acquisition unit 12a acquires a speech text (text data) of a user input from an input unit 25 of the user terminal 20.

The user speech analysis unit 12b analyzes the speech text (the text data) of the user acquired by the user speech text acquisition unit 12a, and performs scoring for answering. An operation example of the user speech analysis unit 12b will be described later.

The response selection unit 12c selects answer texts of a plurality of respective agents to the speech text of the user acquired by the user speech text acquisition unit 12a from the databases (the FAQ-DBs 11b1_AG1 to 11b1_AG3) for each agent storing a question text and an answer text corresponding to the question text. Specifically, the response selection unit 12c selects, from the databases (the FAQ-DBs 11b1_AG1 to 11b1_AG3), answer texts of the plurality of respective agents to the speech text of the user based on the degree of similarity (score) between the speech text of the user acquired by the user speech text acquisition unit 12a and the question text stored in the databases (the FAQ-DBs 11b1_AG1 to 11b1_AG3). An operation example of the response selection unit 12c will be described later.

The communication unit 14 is a communication apparatus which communicates with the user terminal 20 via the network NW (e.g., the Internet). For example, the communication unit 14 receives a speech text of a user transmitted from the user terminal 20. Further, the communication unit 14 transmits screen display data for displaying a screen (see, for example, the screen G1 shown in FIG. 6) including a plurality of agents to the user terminal 20. The screen display data includes displays showing the answer texts of the plurality of respective agents selected by the response selection unit 12c, agent images symbolizing the plurality of respective agents, and organizations to which the plurality of respective agents belong.

### <Configuration Example of the User Terminal 20>

Next, a configuration example of the user terminal 20 will be described.

The user terminal 20 is, for example, an information processing apparatus such as a personal computer. As shown in FIG. 1, the user terminal 20 includes a storage unit 21, a control unit 22, a memory 23, a communication unit 24, the input unit 25, and a display unit 26.

The storage unit 21 is, for example, a nonvolatile storage unit such as a hard disk device or a Read Only Memory (ROM). The storage unit 21 includes a program storage unit 21a.

The program storage unit 21a stores programs to be executed by the control unit 22 (a processor).

The control unit 22 includes the processor (not shown). The processor is, for example, a Central Processing Unit (CPU). The control unit 22 may include one or a plurality of processors. The processor executes a program loaded from the storage unit 21 (the program storage unit 21a) into the memory 23 (e.g., Random Access Memory (RAM)), thereby functioning as a screen display unit 22a. This unit may be implemented by hardware.

When the communication unit 24 receives screen display data transmitted from the server apparatus 10, the screen display unit 22a displays a screen (see, for example, the screen G1 shown in FIG. 6) including a plurality of agents on the display unit 26 based on the received screen display data. At this time, the screen display unit 22a displays an agent to be preferentially checked by a user among the plurality of agents in a more emphasized form than those of the agents other than the agent that the user should check first. An operation example of the screen display unit 22a will be described later.

The communication unit 24 is a communication apparatus which communicates with the server apparatus 10 via the network NW (e.g., the Internet). For example, the communication unit 24 receives screen display data transmitted from the server apparatus 10. Further, the communication unit 24 transmits a speech text of a user input from the input unit 25 to the server apparatus 10.

The input unit 25 is an input unit that inputs a speech text of a user. The input unit 25 is, for example, an input device such as a keyboard or a mouse. The input unit 25 may be a microphone. When the input unit 25 is a microphone, an input speech text of a user is converted into text data by voice recognition processing.

The display unit 26 is, for example, a display device such as a liquid crystal display.

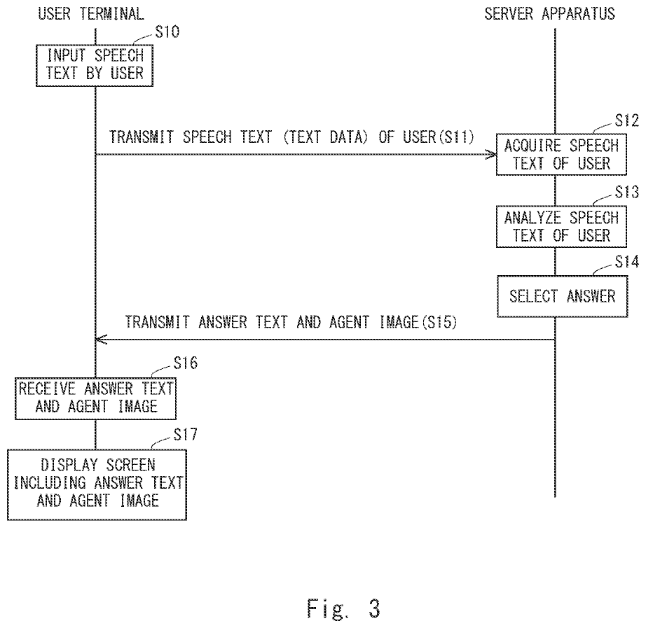

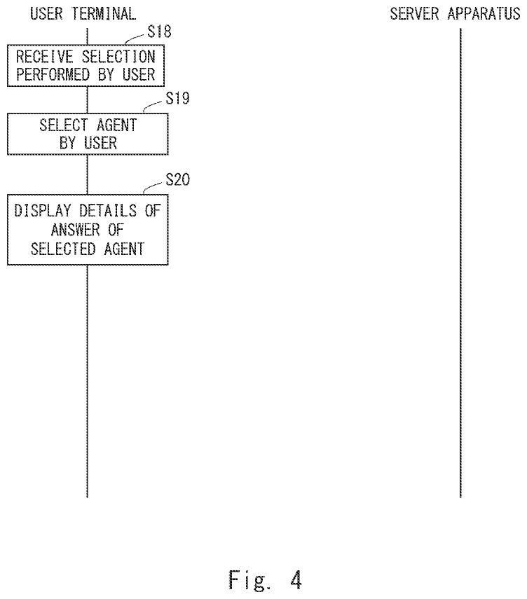

Next, an operation example of the agent display system 1 will be described with reference to FIGS. 3 and 4. FIGS. 3 and 4 are each sequence diagrams of the operation examples of the agent display system 1. In the following description, as shown in FIG. 2, an example in which three agents AG1 to AG3 are stored in the storage unit 11 (the agent information storage unit 11b) will be described.

First, a user inputs a speech text through the input unit 25 of the user terminal 20 (Step S10). Here, it is assumed that “How do I settle expenses?” (text data) is input as the speech text of the user.

Next, the user terminal 20 (the communication unit 24) transmits the speech text of the user input in Step S10 to the server apparatus 10 (Step S11).

Next, the server apparatus 10 (the user speech text acquisition unit 12a) acquires the speech text of the user transmitted from the user terminal 20 (Step S12).

Next, the server apparatus 10 (the user speech analysis unit 12b) executes a user speech analysis (Step S13).

The operation example (the user speech analysis) of the user speech analysis unit 12b will be described below.

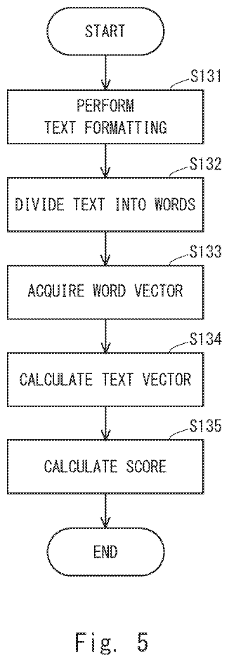

FIG. 5 is a flowchart of the operation example (the user speech analysis) of the user speech analysis unit 12b.

First, the user speech analysis unit 12b performs text formatting on the speech text (text data that is raw data) of the user acquired in Step S12 (Step S131). The text formatting includes, for example, processing for unifying full-width/half-width characters and processing for performing replacement of a specific word.

Next, the user speech analysis unit 12b divides the speech text of the user on which the text formatting has been performed in Step S131 into words (Step S132), and acquires a word vector of each word by referring to a word vector dictionary (not shown) (Step S133). Although not shown in the figure, the word vector dictionary represents the meaning of each word by a vector, and is, for example, stored in the storage unit 11.

Next, the user speech analysis unit 12b calculates a text vector from the word vector acquired in Step S133 (Step S134). The text vector represents a whole text as a vector. The text vector may be calculated, for example, by averaging the elements of the word vectors, or may be calculated using a Deep Neural Network (DNN) such as a Long Short-Term Memory (LSTM).

Next, the user speech analysis unit 12b calculates a score between the text vector (the text vector of the speech text of the user) calculated in Step S134 and the text vector of each question text stored in the FAQ-DB 11b1 (Step S135). The score is an index (a numerical value) indicating a degree of similarity between the speech text of the user and each question text stored in the FAQ-DB 11b1. In the following description, the score may be referred to as a degree of similarity. The score may be calculated, for example, by calculating a distance between the vectors by a cosine distance or by using a classification model of machine learning (such as a Support Vector Machine (SVM) and a Convolutional Neural Network (CNN)). In such a case, the agent feature 11b2 may be used.

The processing of Step S135 is executed for each agent. For example, for the agent AG1, the score between the speech text of the user (in this case, the text vector of “How do I settle expenses?”) and the text vector of each question text stored in the FAQ-DB 11b1_AG1 (see FIG. 2) of the agent AG1 is calculated. For the agents AG2 and AG3, the score is calculated in a manner similar to that in the case of the agent AG1.

Referring back to FIG. 3, the description of the operation example of the agent display system 1 will be continued.

Next, the server apparatus 10 (the response selection unit 12c) selects, from the databases (the FAQ-DBs 11b1_AG1 to 11b1_AG3), answer texts of the plurality of respective agents to the speech text of the user based on the degree of similarity (score) between the speech text of the user acquired by the user speech text acquisition unit 12a and the question text stored in the databases (the FAQ-DBs 11b1_AG1 to 11b1_AG3) (Step S14). For example, for the agent AG1, the response selection unit 12c selects, from the FAQ-DB 11b1_AG1, an answer text (an answer text having the highest score) to the speech text of the user based on a degree of similarity between the speech text of the user and each question text stored in the FAQ-DB 11b1_AG1. For the agents AG2 and AG3, the response selection unit 12c selects answer texts in a manner similar to that in the case of the agent AG1.

Here, it is assumed that, for the agent AG1, “Do you want to settle the expenses for the business trip?” (the score: 0.8) is selected from the FAQ-DB 11b1_AG1 as the answer text (the overview) having the highest score for the speech text of the user. Further, it is assumed that, for the agent AG2, “Do you want to settle the expenses for the experiment and research?” (the score: 0.7) is selected from the FAQ-DB 11b1_AG2 as the answer text (the overview) having the highest score for the speech text of the user. Further, it is assumed that, for the agent AG3, “Do you want to settle the expenses for your department's social gathering?” (the score: 0.6) is selected from the FAQ-DB 11b1_AG3 as the answer text (the overview) having the highest score for the speech text of the user. Further, the server apparatus 10 (the response selection unit 12c) rearranges the agents and the answers in a descending order based on the highest score that each agent has.

Next, the server apparatus 10 (the communication unit 14) transmits screen display data for displaying a screen (see, for example, the screen G1 shown in FIG. 6) including a plurality of agents to the user terminal 20 (Step S15). The screen display data includes displays showing the answer texts (e.g., the answer text of the agent AG1 “Do you want to settle the expenses for the business trip?”, the answer text of the agent AG2 “Do you want to settle the expenses for the experiment and research?”, and the answer text of the agent AG3 “Do you want to settle the expenses for your department's social gathering?”) of the plurality of respective agents selected by the response selection unit 12c, agent images symbolizing the plurality of respective agents (e.g., the agent images 11b3_AG1 to 11b3_AG3 symbolizing the plurality of respective agents AG1 to AG3), and organizations (e.g., “in charge of business trip expenses”, “in charge of expenses”, and “in charge of social gatherings”) to which the plurality of respective agents belong.

Next, the user terminal 20 (the communication unit 24) receives the screen display data transmitted from the server apparatus 10 (Step S16).

Next, the user terminal 20 (the screen display unit 22a) displays a screen (see, for example, the screen G1 shown in FIG. 6) including a plurality of agents on the display unit 26 based on the screen display data received in Step S16 (Step S17).

The screen including a plurality of agents includes displays showing the answer texts (e.g., the answer text of the agent AG1 “Do you want to settle the expenses for the business trip?”, the answer text of the agent AG2 “Do you want to settle the expenses for the experiment and research?”, and the answer text of the agent AG3 “Do you want to settle the expenses for your department's social gathering?”) of the plurality of respective agents selected by the response selection unit 12c, agent images symbolizing the plurality of respective agents (e.g., the agent images 11b3_AG1 to 11b3_AG3 symbolizing the plurality of respective agents AG1 to AG3), and organizations (e.g., “in charge of business trip expenses”, “in charge of expenses”, and “in charge of social gatherings”) to which the plurality of respective agents belong.

At this time, the agent that the user should check first among the plurality of agents is displayed in a more emphasized form than those of the agents other than the agent that the user should check first. For example, the agent that the user should check first is displayed in a size larger than those of the other agents (e.g., the agent images 11b3_AG2 and 11b3_AG3), like that of the agent (e.g., the agent image 11b3_AG1) shown in FIG. 6. FIG. 6 shows an example of a screen displayed on the display unit 26. In other words, the display size of the agent is changed in accordance with the magnitude of the score that each agent has. At this time, the respective agents are sorted in the order of scores. Each agent displays the overview of the answer in a simple display format. As simple display timings, various timings can be considered. For example, it may be always displayed, it may be displayed at the timing when a user hovers the mouse over the agent, or it may be displayed at a fixed time.

Note that the agent that the user should check first is the agent corresponding to the answer text having the highest score among the plurality of agents. Here, the agent AG1 corresponding to the answer text “Do you want to settle the expenses for the business trip?” having the highest score (0.8) among the plurality of agents AG1, AG2, and AG3 is the agent that the user should check first. The other agents are agents other than the agent that the user should check first among the plurality of agents. In this case, the agents AG2 and AG3 other than the agent AG1 that the user should check first are the other agents.

Referring back to FIG. 4, the description of the operation example of the agent display system 1 will be continued.

Next, the user terminal 20 receives the selection performed by the user with regard to the plurality of agents (the agent images 11b3_AG1 to 11b3_AG3) displayed on the screen (Step S18).

Next, when one of the plurality of agents (the agent images 11b3_AG1 to 11b3_AG3) is selected by the user (e.g., the user hovers the mouse over it) (Step S19), the answer (e.g., the details) of the selected agent is displayed on the display unit 26 (Step S20).

As described above, according to this embodiment, it is possible to reduce the trouble of a user confirming an answer (or answers) while increasing the possibility of presenting an answer (or answers) of high value to the user without omission.

The reason why it is possible to increase the possibility of presenting all answers valuable to a user is that the answer texts of the plurality of respective agents are displayed on the display unit 26. The reason why it is possible to help to prevent a user from being subject to the inconvenience of having to check answers is that the agent that the user should check first is displayed in a more emphasized form than those of the other agents.

In order to simplify the management system and secure the correct answer rate, a unit of the agent construction is a department, and each agent is independently operated in some cases. In such cases, it is necessary for a user to use each agent separately.

On the contrary, according to this embodiment, since a plurality of agents (answers) are simultaneously displayed and unified into one interface (the display unit 26), it is possible to reduce the burden (the burden of using each agent separately) on a user.

Further, according to this embodiment, the accuracy of answers is improved (a user can easily arrive at the answer). That is, even when the first presented agent has not presented the answer a user has intended to obtain, the answer texts of other agents or the overviews of these answer texts have been presented, so that the user can select another agent having the answer he/she has intended to obtain.

Further, according to this embodiment, it is possible to achieve a natural interaction (a change of agents). That is, according to this embodiment, when a plurality of agents participate in a conversation, a user can select the agent he/she wants to talk with by himself/herself. Thus, the reason for selecting the agent is clear and it is possible to reduce the cognitive burden on the user.

Further, according to this embodiment, when another agent is selected, it is possible to implicitly detect that the answer displayed on the main screen was wrong (it can be used for learning data).

Further, according to this embodiment, since the answers of other agents can be confirmed, new knowledge can be provided to the user in. That is, according to this embodiment, since a user can list the answers of a plurality of agents to his/her question, the user can simultaneously acquire from the answers of the plurality of agents the preliminary knowledge which he/she has not originally intended to acquire.

Next, a modified example will be described.

In the above-described embodiment, as an example in which an agent to be preferentially checked by a user among a plurality of agents is displayed in a more emphasized form than those of the agents other than the agent that the user should check first, the example (see FIG. 6) has been described in which the agent (e.g., the agent image 11b3_AG1) that the user should check first is displayed in a size larger than those of the other agents (e.g., the agent images 11b3_AG2 and 11b3_AG3). However, the present disclosure is not limited thereto. A description will be given below of another example (the modified example) in which an agent to be preferentially checked by a user among a plurality of agents is displayed in a more emphasized form than those of the agents other than the agent that the user should check first.

### Modified Example 1

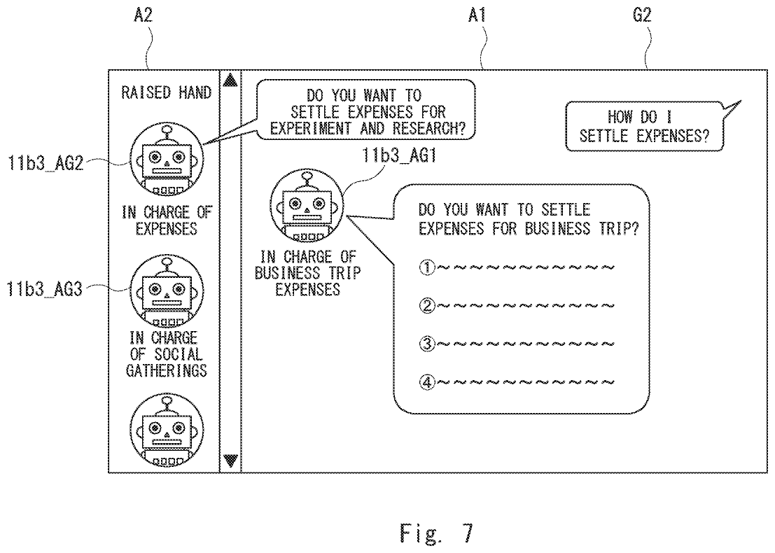

FIG. 7 shows a modified example 1 of a screen G2 displayed on the display unit 26.

For example, as shown in FIG. 7, the agent image (e.g., the agent image 11b3_AG1 symbolizing the agent AG1) symbolizing an agent to be preferentially checked by a user may be displayed in a first display area A1 (a main area), the agent images (e.g., the agent images 11b3_AG2 and 11b3_AG3 respectively symbolizing the agents AG2 and AG3) symbolizing agents other than the agent that the user should check first may be displayed in a second display area A2 (a sub area). At this time, the respective agents are sorted in the order of scores. Each agent displays the overview of the answer in a simple display format. As simple display timings, various timings can be considered. For example, it may be always displayed, it may be displayed at the timing when a user hovers the mouse over the agent, or it may be displayed at a fixed time. Note that the first display area A1 is larger than the second display area A2.

### Modified Example 2

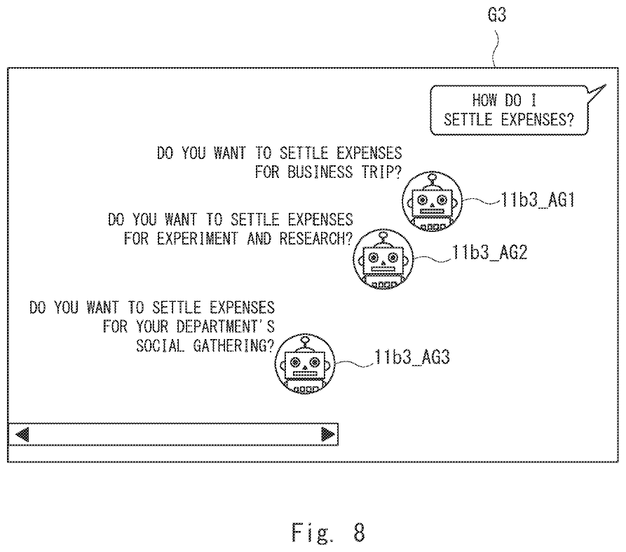

FIG. 8 shows a modified example 2 of a screen G3 displayed on the display unit 26.

Further, for example, as shown in FIG. 8, the answer text (e.g., the answer text of the agent AG1 “Do you want to settle the expenses for the business trip?”) of the agent that the user should check first may be displayed in a size larger than those of the answer texts (e.g., the answer text of the agent AG2 “Do you want to settle the experiment and research expenses?” and the answer text of the agent AG3 “Do you want to settle the expenses for your department's social gathering?”) of the other agents. In other words, the display size of the answer is changed in accordance with the magnitude of the score that each agent has. At this time, the respective answers are sorted in the order of scores. Each of the answers is displayed so that the agent to which it belongs can be clearly specified.

### Modified Example 3

Further, although not shown in the figure, the agent (e.g., the agent AG1) that the user should check first may be displayed in density higher (a color deeper) than those of the other agents (e.g., the agents AG2 and AG3).

### Modified Example 4

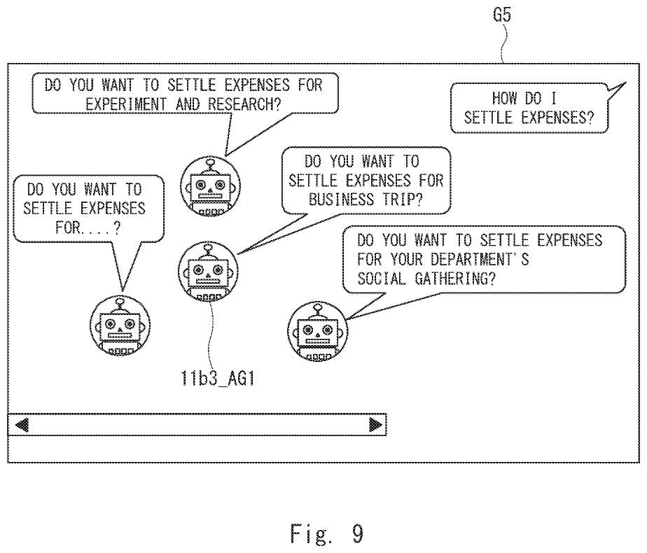

FIG. 9 shows a modified example 4 of a screen G5 displayed on the display unit 26.

As shown in FIG. 9, the other agents may be displayed so that the other agents surround the agent (e.g., the agent image 11b3_AG1 symbolizing the agent AG1) that the user should check first.

### Modified Example 5

Although not shown in the figure, the screen displayed on the display unit 26 may further include an additional display that is additionally displayed near the agent that the user should check first. The additional displays include characters, symbols, figures, and the like. The number of additional displays may be one or larger. The additional display may be a moving image or a still image.

### Modified Example 6

Although not shown in the figure, the agent (e.g., the agent image 11b3_AG1 symbolizing the agent AG1) that the user should check first may be displayed so that it blinks.

### Modified Example 7

Although not shown in the figure, in the screen displayed on the display unit 26, the agent (e.g., the agent image 11b3_AG1 symbolizing the agent AG1) that the user should check first may be displayed as a moving image, and the other agents (e.g., the agent images 11b3_AG2 and 11b3_AG3 respectively symbolizing the agents AG2 and AG3) may be displayed as still images.

### Modified Example 8

As shown in FIG. 9, displays (e.g., “in charge of business trip expenses”, “in charge of expenses”, and “in charge of social gatherings”) showing organizations to which the plurality of respective agents belong may be omitted.

In the above-described embodiment, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The numerical values shown in the above-described embodiment are all examples, and it is needless to say that any other suitable numerical values can be used.

The above-described embodiment is merely illustrative in all respects. The present disclosure is not limited by the description of the above-described embodiment. The present disclosure may be implemented in various other ways without departing from its spirit or principal features.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An agent display method for simultaneously displaying a plurality of agents each configured to respond to a speech text of a user, the agent display method comprising:
a speech text acquisition step of acquiring the speech text of the user;
an answer selection step of selecting, from a database of each of the agents storing a question text and an answer text corresponding to the question text, the answer text of each of the plurality of agents to the speech text of the user; and
an agent display step of displaying a screen including the plurality of agents,
wherein the agent display step includes displaying the agent that the user should check first among the plurality of agents in a more emphasized form than those of the agents other than the agent that the user should check first.

2. The agent display method according to claim 1, wherein
the screen includes an agent image symbolizing the agent that the user should check first and agent images symbolizing the other agents, and
the agent image symbolizing the agent that the user should check first is displayed in a size larger than those of the agent images symbolizing the other agents.

3. The agent display method according to claim 1, wherein
the screen includes a first display area and a second display area,
the first display area is larger than the second display area,
the agent that the user should check first is displayed in the first display area, and
the other agents are displayed in the second display area.

4. The agent display method according to claim 1, wherein
the screen includes the answer text of the agent that the user should check first and the answer texts of the other agents, and
the answer text of the agent that the user should check first is displayed in a size larger than those of the answer texts of the other agents.

5. The agent display method according to claim 1, wherein the agent that the user should check first is displayed in density higher than those of the other agents.

6. The agent display method according to claim 1, wherein the other agents are displayed so that the other agents surround the agent that the user should check first.

7. The agent display method according to claim 1, wherein the screen further includes an additional display that is additionally displayed near the agent that the user should check first.

8. The agent display method according to claim 1, wherein the agent that the user should check first is displayed so that it blinks.

9. The agent display method according to claim 1, wherein
the agent that the user should check first is displayed as a moving image, and
the other agents are displayed as still images.

10. The agent display method according to claim 1, wherein the screen further includes displays showing organizations to which the plurality of respective agents belong.

11. The agent display method according to claim 1, wherein the answer selection step includes selecting the answer texts of the plurality of respective agents to the speech text of the user from the database based on a degree of similarity between the speech text of the user and the question text stored in the database.

12. The agent display method according to claim 1, wherein the answer selection step includes selecting the answer texts of the plurality of respective agents to the speech text of the user from the database based on the degree of similarity between the speech text of the user and the question text stored in the database and a feature of the agent.

13. The agent display method according to claim 11, wherein the answer text of the agent that the user should check first is the answer text corresponding to the question text among the answer texts of the plurality of respective agents selected in the answer selection step, the question text having a highest degree of similarity to the answer text.

14. The agent display method according to claim 1, wherein the answer text of each of the plurality of agents to the speech text of the user is an overview of the answer text.

15. The agent display method according to claim 14, further comprising:
a selection receiving step of receiving the selection performed by the user with regard to the agents; and
a step of displaying a detail of the answer text of the agent selected by the user from among the agents.

16. A non-transitory computer readable medium storing a program for causing an information processing apparatus comprising at least one processor to execute:
speech text acquisition processing of acquiring a speech text of a user;
answer selection processing of selecting, from a database of each of a plurality of agents storing a question text and an answer text corresponding to the question text, the answer text of each of the plurality of agents to the speech text of the user; and
agent display processing of displaying a screen including the plurality of agents,
wherein the agent display processing includes displaying the agent that the user should check first among the plurality of agents in a more emphasized form than those of the agents other than the agent that the user should check first.

17. An agent display system configured to simultaneously display a plurality of agents each configured to respond to a speech text of a user, the agent display system comprising:
a speech text acquisition unit configured to acquire the speech text of the user;
an answer selection unit configured to select, from a database of each of the agents storing a question text and an answer text corresponding to the question text, the answer text of each of the plurality of agents to the speech text of the user; and
an agent display unit configured to display a screen including the plurality of agents,
wherein the agent display unit displays the agent that the user should check first among the plurality of agents in a more emphasized form than those of the agents other than the agent that the user should check first.
